(19) United States
(12) Patent Application Publication
(10) Pub. No.: US 2011/0059332 A1
(43) Pub. Date: Mar. 10, 2011

(54) Oxidation and Corrosion Resistant and Ductile Alloy Composition and Method of Making

(76) Inventors: Canan Uslu Hardwicke, Simpsonville, SC (US); Kivilcim Onal Hance, Greer, SC (US); Paul Stephen DiMascio, Greer, SC (US)

(21) Appl. No.: 12/557,060

(22) Filed: Sep. 10, 2009

(51) Int. Cl. B32B 15/01; C22C 30/00; C22C 19/07

(52) U.S. Cl. 428/615; 420/583; 420/588; 420/585; 420/437; 420/591

(57) ABSTRACT

Composition containing a MCrAlY, wherein M is selected from the group consisting of cobalt (Co), nickel (Ni), iron (Fe) and mixtures thereof, and germanium in an amount of about 10% by weight or less of germanium. Coated articles coated with the composition are also provided.

The present invention relates to metallic compositions suitable for use in high temperature environments. In particular, the present invention provides a metallic alloy composition that can be used by itself as a component or can be used to protect metallic components from oxidation and hot corrosion. More specifically, the present invention provides a metallic alloy composition containing germanium which simultaneously improves oxidation and hot corrosion resistance and ductility of the alloy, thereby providing better temperature and corrosion capability without sacrificing ductility (strain tolerance).

### BACKGROUND OF THE INVENTION

In harsh environments such as a turbine engine, metallic overlay or bond coatings (i.e. MCrAlY and/or aluminides) and thermal barrier coatings (TBC's) protect the underlying metal alloy substrate against heat and the corrosive environment of the hot gases. The presence of the TBC provides a heat reducing barrier between the hot combustion gases and the metal alloy substrate, and can prevent, mitigate, or reduce potential heat, corrosion, and/or oxidation induced damage to the substrate.

It is known that when alloying elements such as Al, Si, Zr, Pt, etc. are added to gamma+beta phase containing MCrAlY alloys (M=Co, Ni or Fe) to improve oxidation and/or corrosion resistance, the strain to crack resistance (or the ductility) of the new MCrAlY is often compromised. Lowered ductility may cause fatigue cracks at low temperatures while the turbine is cycling between room temperature and high operation temperatures.

U.S. Pat. No. 7,157,151 to Creech et al. describes coating systems and processes for applying a selected coating system on a metallic substrate. The coating system includes two or more coating layers, the first layer including a MCrAl(Y,Hf)-type coating which is overlaid with a second coating composition that includes a metallic composition different from the MCrAl(Y,Hf) coating composition and includes one or more of a platinum, silicon containing composition; a platinum, silicon, aluminum containing composition; a platinum, silicon, chromium containing composition; an aluminum, silicon containing composition; and an aluminum, silicon, chromium containing composition; each optionally combined with one or more of chromium, hafnium, lanthanum, manganese, yttrium and mixtures of these metals. Additionally the platinum in the metallic compositions can be exchanged in whole or in part by another expensive noble metal. The resulting coating composition is subsequently heat treated to provide a diffused multilayer corrosion-resistant coating. The challenge with alloying additions is that as the beneficial elements are added to MCrAlY materials, the room temperature ductility of the alloy decreases, making it easy for the fatigue cracks to start and propagate through the coating thickness and to the substrate.

Therefore, a need exists to provide a simple system and process for balanced and better oxidation and/or corrosion resistance and ductility of metallic surfaces in harsh environments. The present invention fills that need.

### BRIEF DESCRIPTION OF THE INVENTION

It has been found, according to the invention, that the addition of germanium to MCrAlY, wherein M is selected from the group consisting of Co, Ni, Fe and mixtures thereof, in an amount of 10% by weight or less of germanium results in a MCrAlY-germanium composition exhibiting improved oxidation and corrosion resistance over MCrAlY not containing germanium. It has also been found that the addition of germanium to MCrAlY does not exhibit any reduction in ductility as compared to the ductility of the MCrAlY not containing germanium. It has further been found that addition of germanium to MCrAlY composition provides improved thermal barrier coating (TBC) life when used as a metallic bond coat under the ceramic TBC. Furthermore, the better performance of the MCrAlYGe compositions can be optimized by further adding other beneficial elements such as (but not limited to) La, Ce, Hf, Ru, Re, Pd, and Al.

In one aspect, there is provided an alloy composition comprising an MCrAlY, wherein M is selected from the group consisting of cobalt (Co), nickel (Ni), or iron (Fe) and mixtures thereof, and germanium in an amount of about 10% by weight or less of germanium.

In a further aspect, there is provided a coated article comprising a metallic substrate and a coating present on the metallic substrate comprising a MCrAlY alloy including germanium in an amount of about 10% by weight or less. In another embodiment of the coated article Hf and Pd may also be present.

The invention accomplishes the oxidation and corrosion resistance and improvement of TBC life in one single, ductile metallic coating as opposed to the multiple coating layers in U.S. Pat. No. 7,157,151 mentioned above.

### BRIEF DESCRIPTION OF THE DRAWINGS

FIG. 1 is a metallurgical cross section of the baseline MCrAlY coating and the same coating with 1 wt % Si and 1 wt % Ge addition after testing at 1900 F for 2000 h;

FIG. 2 is a plot comparing the effect of alloying additions Si vs Ge to the baseline CoNiAlY on strain tolerance (i.e. ductility);

FIG. 3 reports the hot corrosion resistance of the baseline and modified MCrAlY coatings (also comparing Si vs Ge additions) tested at 1800 F for 2 weeks in sulfate environment (60% CaSO₄+20% MgSO₄+15% Na₂SO₄+5% K₂SO₄);

FIG. 4 shows the effect of addition of Ge to the bond coat on the TBC life.

### DETAILED DESCRIPTION OF THE INVENTION

In a first aspect, the present invention provides a composition 1) suitable for application to a metal substrate such as a turbine component, 2) for use as the component itself. The composition comprises MCrAlY, wherein M is selected from the group consisting of Co, Ni and Fe and mixtures thereof, and germanium in an amount of about 10% by weight or less of germanium. The Ge containing composition may further have one or more additional beneficial elements such as Hf, Pd, and Al.

In a further aspect the invention provides a coated article comprising a metallic substrate and a coating present on the metallic substrate comprising a MCrAlY alloy including germanium in an amount of about 10% by weight or less.

According to the invention, it has been discovered that the presence of germanium in MCrAlY gives an improvement in oxidation resistance without any reduction in ductility. This is also significant improvement over coatings containing Si which is usually assumed to behave the same way as Ge due to being in the same Group of the Periodic Table.

In a further aspect, it has been found that the presence of germanium in amounts of 10% by weight or less permits higher loading of other beneficial elements which usually cause a significant decrease in ductility when added to the MCrAlY alloy without any Ge. Examples of such beneficial elements are Al, Cr, Si, Mo, Hf, Ce, La, Mn, Y, noble metals, and mixtures thereof.

In another aspect, the composition of the invention is comprised of germanium in an amount of about 1% by weight, aluminum in an amount of about 12% by weight, nickel in an amount of about 32% by weight, chromium in an amount of about 22% by weight, yttrium in an amount of about 0.5% by weight, and balance Co.

In yet another aspect, the composition of the invention contains an element selected from Al, Cr, Si, Mo, Ce, Hf, La, Mn, Y, a noble metal, and mixtures thereof.

The composition of the invention may also comprise a MCrAlYX, wherein M is selected from cobalt (Co), nickel (Ni), iron (Fe) and mixtures thereof, and X is selected from the group consisting of Ge, Hf, and Pd. The Pd may be present in an amount of 0.5-10 wt %, the Hf may be present in an amount of 0.01-0.6 wt %, and Y may be present in an amount of 0.01-1 wt %.

In a further aspect, composition of the invention comprises an MCrAlY composition; germanium; and a Group 4B metal selected from hafnium, zirconium, titanium, and combinations thereof; a noble metal selected from ruthenium, rhenium, platinum, palladium, rhodium, and combinations thereof, wherein M is nickel, or a combination of nickel and a metal selected from cobalt, iron, and a combination of cobalt and iron, wherein the amount of yttrium is 0.1 to 5 weight percent, based on the total weight of the composition, wherein the amount of germanium is 0.1 to 10 weight percent, based on the total weight of the composition, wherein the amount of the Group 4B metal is 0 to 3 weight percent, based on the total weight of the composition wherein 0 to about 10 weight percent of a noble metal, and wherein the amount of aluminum is 5 to 20 weight percent, based on the total weight of the composition. The composition typically comprises 16 to 50 weight percent cobalt; 20 to 35 weight percent nickel; 15 to 25 weight percent chromium; 7 to 15 weight percent aluminum; 0.15 to 2 weight percent yttrium; 0.1 to 1 weight percent hafnium; 1 to 10 weight percent palladium; and 0.5 to 2.5 weight percent germanium; wherein the weight percentages are based on the total weight of the composition.

The composition of the invention can be applied by conventional methods as will be known to persons of skilled in the art. Typically, the composition may be applied as an overlay coating by VPS, HVOF, EBPVD, direct-printing/writing, sputtering, slurry coating, paint spraying, and/or plating techniques, to thereby improve the oxidation resistance of the turbine part. Alternatively, the composition may be applied as a bond coat under a thermal barrier coating (TBC) without sacrificing the TBC life, and in certain instances may improve TBC life.

In addition, it has been found, based on initial evaluations, that the Ge addition to the bond coat does not negatively impact the thermal barrier coating (TBC) life. The composition comprising germanium is accordingly useful as a coating, as well as a superalloy component.

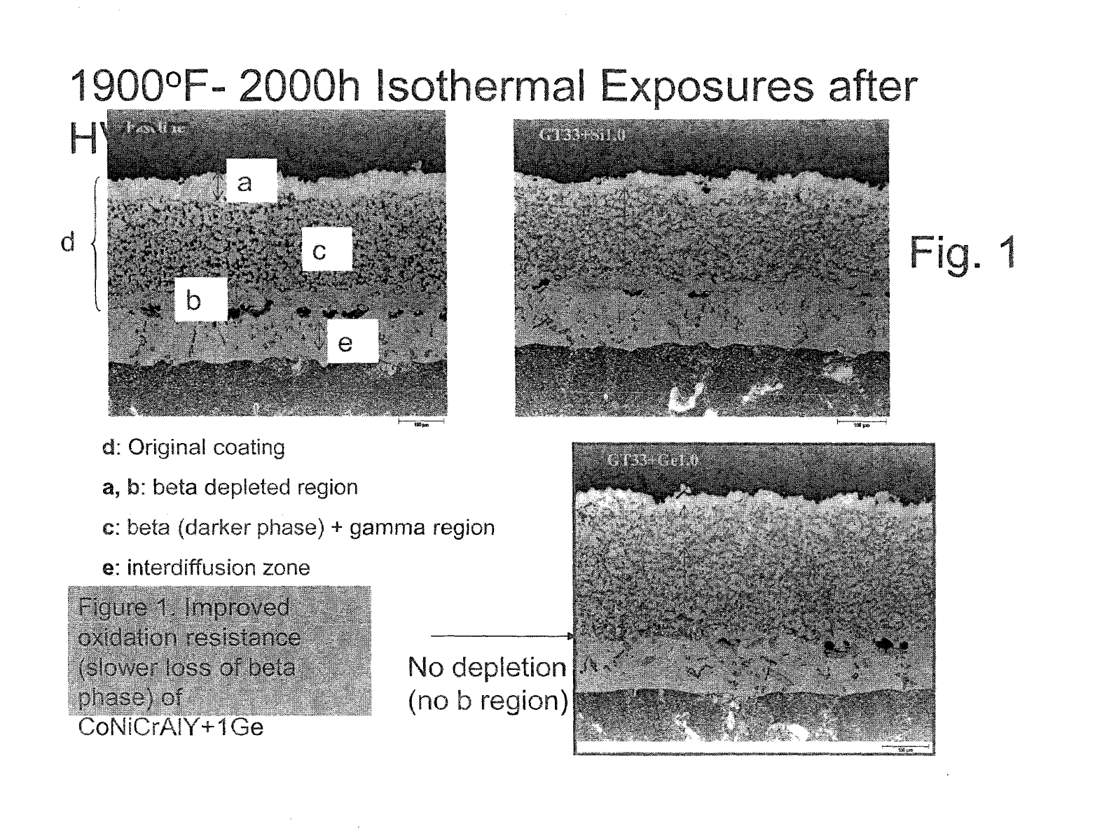

Referring specifically to the figures, FIG. 1 is a metallurgical cross section of the baseline MCrAlY coating and the same coating with 1 wt % Si and 1 wt % Ge addition after testing at 1900 F for 2000 h. It shows that the depletion of dark beta phase (i.e. amount of aluminum containing beta phase is proportional to oxidation resistance of the coating) is minimal in the presence of Ge added coating as compared to the baseline coating with no additions, or the coating with 1 wt % Si addition.

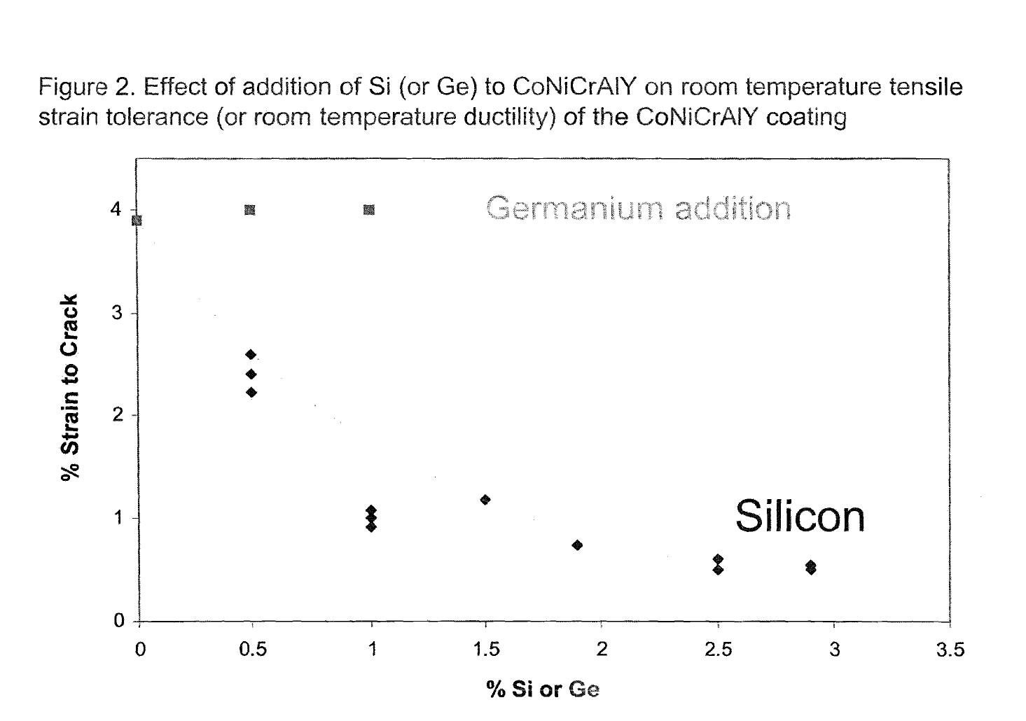

FIG. 2 is a plot comparing the effect of alloying additions Si vs Ge to the baseline CoNiCrAlY on strain tolerance (i.e. ductility). It shows that addition of Ge does not lower the room temperature ductility and is preferred addition.

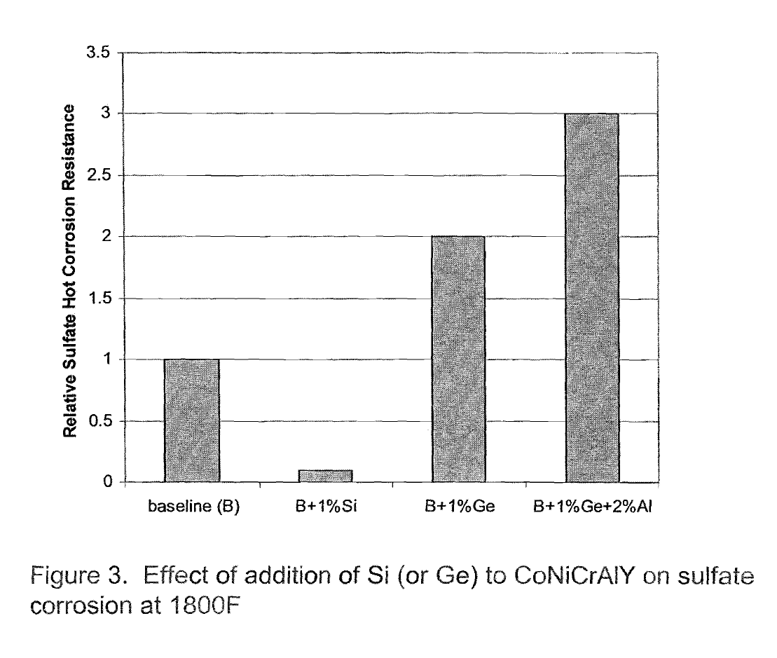

FIG. 3 reports the relative hot corrosion resistance of the baseline and modified MCrAlY coatings tested at 1800 F for 2 weeks in sulfate environment (60% CaSO₄+20% MgSO₄+15% Na₂SO₄+5% K₂SO₄). It is clear that the addition of Ge improves the hot corrosion resistance of the baseline MCrAlY while addition of same amount of silicon lowers the corrosion resistance. FIG. 3 also shows that the better corrosion resistance of Ge containing alloy can be further improved by addition of 2% more Al.

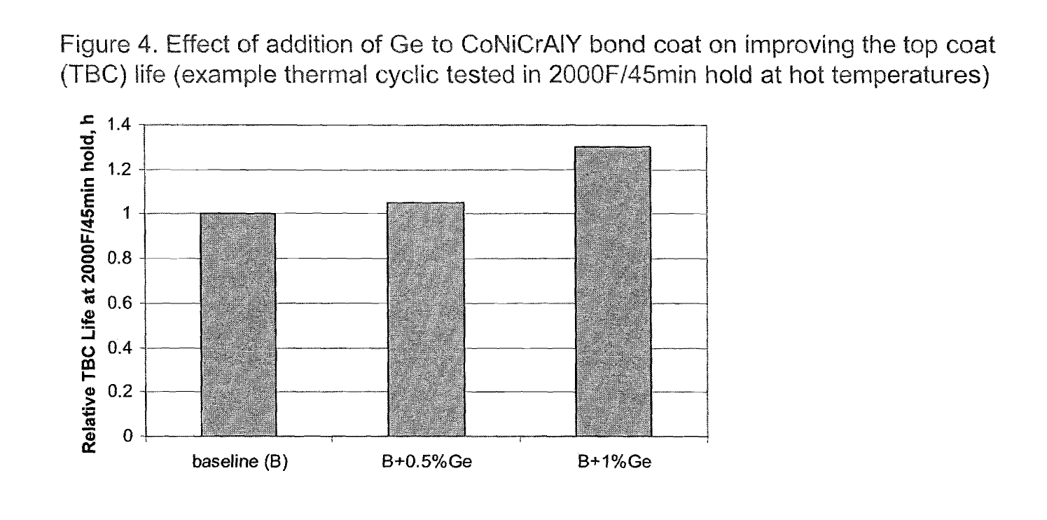

FIG. 4 shows the effect of addition of Ge to the bond coat on the TBC life. After the thermal cyclic tests at 2000 F with 45 minute holds at this temperature, TBC life improved as the amount of Ge was increased.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A composition comprising a MCrAlY, wherein M is selected from the group consisting of cobalt (Co), nickel (Ni), iron (Fe) and mixtures thereof, and germanium in an amount of about 10% by weight or less of germanium.

2. A composition according to claim 1 wherein M is Ni.

3. A composition according to claim 1 wherein M is Co.

4. A composition according to claim 1 wherein M is Fe.

5. A composition according to claim 1 wherein M is Ni and Co.

6. A composition according to claim 1 wherein M is Fe, Ni and Co.

7. A composition according to claim 1 wherein the germanium is present in an amount of about 1% by weight.

8. A composition according to claim 1 wherein the germanium is present in an amount of about 1% by weight, aluminum is present in an amount of about 12% by weight, nickel is present in an amount of about 32% by weight, chromium is present in an amount of about 22% by weight, yttrium is present in an amount of about 0.5% by weight, balance Co.

9. A composition according to claim 1 and further comprising an element selected from the group consisting of Al, Cr, Si, Mo, Ce, Hf, La, Mn, Y, a noble metal, and mixtures thereof.

10. A composition comprising a MCrAlYX, wherein M is selected from the group consisting of cobalt (Co), nickel (Ni), iron (Fe) and mixtures thereof, and X is selected from the group consisting of Ge, Hf, Pd and mixtures thereof.

11. A composition according to claim 10 wherein the Pd is present in an amount of 0.5-10 wt %, the Hf is present in an amount of 0.01-0.6 wt %, and Y is present in an amount of 0.01-1 wt %.

12. A coated article comprising a metallic substrate coated with a composition comprising a MCrAlY, wherein M is selected from the group consisting of cobalt (Co), nickel (Ni), iron (Fe) and mixtures thereof, and germanium in an amount of about 10% by weight or less of germanium.

13. A coated article according to claim 12 wherein Hf and Pd are present.

14. A composition, comprising:
an MCrAlY composition;
germanium; and
a Group 4B metal selected from the group consisting of hafnium, zirconium, titanium, and combinations thereof;
a noble metal selected from the group consisting of ruthenium, rhenium, platinum, palladium, rhodium, and combinations thereof,
wherein M is nickel, or a combination of nickel and a metal selected from the group consisting of cobalt, iron, and a combination of cobalt and iron, or a combination of cobalt and nickel,
wherein the amount of yttrium is 0.1 to 5 weight percent, based on the total weight of the composition,
wherein the amount of germanium is 0.1 to 10 weight percent, based on the total weight of the composition,
wherein the amount of the Group 4B metal is 0 to 3 weight percent, based on the total weight of the composition,
wherein 0 to about 10 weight percent of a noble metal, and
wherein the amount of aluminum is 5 to 20 weight percent, based on the total weight of the composition.

15. A composition according to claim 1 wherein the composition comprises 16 to 50 weight percent cobalt; 20 to 35 weight percent nickel; 15 to 25 weight percent chromium; 7 to 15 weight percent aluminum; 0.15 to 2 weight percent yttrium; 0.1 to 1 weight percent hafnium; 1 to 10 weight percent palladium; and 0.5 to 2.5 weight percent germanium; wherein the weight percentages are based on the total weight of the composition.
